(19) United States
(12) Patent Application Publication
(10) Pub. No.: US 2011/0297252 A1
(43) Pub. Date: Dec. 8, 2011

(54) PRESSURE REDUCING VALVE CONTROL

(75) Inventors: Richard James Hurley, Somerset (GB); Mark Nicholas Lock, Cambridgeshire (GB); John Henry May, Beds (GB)

(73) Assignee: Aquavent UK Limited, Peterborough, Cambridgeshire (GB)

(21) Appl. No.: 12/664,150

(22) PCT Filed: Jun. 13, 2008
(86) PCT No.: PCT/GB2008/050445

§ 371 Date: Jun. 1, 2010

(30) Foreign Application Priority Data
Jun. 13, 2007 (GB) 0711413.5

(51) Int. Cl. F16K 31/12

(52) U.S. Cl. 137/488

(57) ABSTRACT

An improved pilot valve assembly (14) for hydraulically controlling a pressure reducing valve (12) to maintain and further vary the outlet pressure (P2) of the pressure reducing valve (12) in response to increased flow (f) through the valve (12). The pilot valve assembly (14) comprising first and second movable valve members (100,102). The first and second moveable members (100,102) being acted on by a velocity head pressure sensed by a downstream Pitot tube (90) and a downstream outlet pressure (P2) in a balanced arrangement such that they move in response to both the velocity head and downstream pressure (P2) to open and close the pilot valve (14) and so main valve (12) to both maintain and vary the outlet pressure (P2).

The present invention relates to pressure reducing valves (PRV), in particular for use in water supply systems. More specifically it relates to the control of such valves by the use of a pilot valve arrangement, and particularly it relates to a pilot valve arrangement which uses a hydraulic means for automatically sensing changes in the flow, and in particular flow velocity, and changing the valve setting.

In the supply of water from a source, i.e. mains supply, to a multiplicity of end users, it is conventional practice to pass the supply through a PRV, which may for example, reduce pressure from a mains pressure of about 70 metres to 15-20 metres. This is desirable as a lower operating pressure greatly reduces leakage rate, prolongs the life of the system, reduces labour costs in repairing and maintaining the system, and reduces the frequency of burst mains.

A conventional PRV system comprises a main valve through which the main supply flows and which opens and closes to vary the pressure delivered. The main valve is controlled by a pilot valve. Most PRV systems in actual use in the water supply industry are used to maintain a fixed outlet pressure, with the pilot valve opening and closing the main valve in order to maintain the outlet pressure at a manually set fixed level irrespective of flow rate. This fixed pressure needs to be set at a level sufficiently high for a user remote from the source of supply to have a reasonable pressure at the point of use. However the demands on the water supply system may vary greatly. At some times, a majority of the consumers connected to the system may require a supply and the pressure in the system as a whole must be sufficient to supply this need. At other times though, such as during the night, very few consumers will require the water supply and the pressure could, with adequate safety, be reduced.

There have been developed flow modulated PRV arrangements, in which the pressure is increased in response to an increased flow, and vice versa in order to meet the problem of varying demand and keep the outlet pressure as low as possible for the required flow rate.

Some of these flow modulated PRV control arrangements utilise electronic controllers and pilot valve arrangements which include miniature solenoid valves and electronic sensors. These are however undesirable since they require an electrical power supply which may not be available, or a battery supply which means that they cannot work continuously. They are also generally complex and expensive. They are also unreliable. Furthermore such electronic sensing arrangements generally only sample the flow and pressure periodically (to reduce power loads etc). As a result their response time is slow and intermittent and they do not respond instantaneously.

Hydraulically operated pilot valves and sensing arrangements have also been proposed. These have the advantage of not requiring any power supply and are self contained. However a number of such hydraulic arrangements rely on the use of orifice plates or venturis in the main outlet in order to sense the flow rate. Such orifice plates and venturis in the main outlet introduce their own pressure losses and are undesirable. In particular such orifice plates represent a restriction in the outlet that undesirably limit the maximum flow and pressure that can be delivered. These arrangements also generally rely on the sensed flow pressure directly acting against a biassing spring load and are either fixed and/or limited in the modulation that can be provided. The hydraulic arrangements are also known to suffer from instability and operational problems.

Examples of prior hydraulically controlled PRVs are disclosed in U.S. Pat. No. 3,592,223, U.S. Pat. No. 3,896,843, U.S. Pat. No. 4,715,578, GB 2,267,141 and WO 99/23544. None of these however in practice address the above problems and provide a reliable and stable flow modulation control of the outlet pressure.

It is therefore desirable to provide an improved PRV arrangement, and in particular a pilot valve control of a PRV which addresses the above described problems and/or which more generally offers improvements or an alternative to existing arrangements.

According to the present invention there is therefore provided a pilot valve assembly as described in the accompanying claims.

In an embodiment of a first aspect of the invention there is provided a pilot valve assembly for controlling a pressure reducing valve having an inlet and an outlet. The pilot valve comprises a housing, a first moveable valve member moveably mounted within the housing, and a second moveable valve member moveably mounted within the housing, and moveable relative to the first moveable valve member. The assembly is configured such that relative movement of the first and second moveable valve members opens and closes the pilot valve to control the pressure reducing valve. In addition the second moveable member is mounted within the housing for movement relative thereto in response to the outlet pressure of the pressure reducing valve. The first movable member is mounted within the housing for movement relative thereto in response to a sensed outlet velocity head of the outlet flow from the main valve.

Such an arrangement an provides a relatively simple integrated hydraulically operated pilot valve arrangement that can control the pressure reducing valve to both maintain the outlet pressure and also increase the outlet pressure in response to increased flow.

Preferably the first movable member is mounted within the housing such that the outlet velocity head is configured to act on a first side of the first moveable member. A sensitivity valve may be provided to variably restrict the sensed outlet velocity head acting on a second side of the first movable member. A static outlet pressure of outlet flow from the main valve is configured to act on a second side of the first movable member.

Preferably a proportion of sensed outlet velocity head is configured to act on a second side of the first movable member. A modulator valve may also be used to vary the proportion of the sensed outlet velocity head configured to act on a second side of the first movable member. The proportion of the velocity head acting on the second side of the first moveable member acts to balance and counteract the velocity head acting on the other side. This allows the modulation of the pressure in response to the changes in flow to be adjusted. In addition it provides a smooth and stable modulation to be provided by virtue of the balancing of the velocity head across the first moveable member.

The first moveable member preferably comprises a moveable diaphragm assembly which divides at least a portion of the housing into a velocity head chamber connected to the sensed outlet velocity head on one side of the diaphragm assembly, and an outlet chamber on the other side of the diaphragm assembly and connected to the outlet of the pressure reducing valve.

The second moveable member preferably comprises a diaphragm acted on by the outlet pressure of the pressure reducing valve. In particular the second moveable member comprises a diaphragm defining a wall of the outlet chamber and acted on by the outlet pressure of the pressure reducing valve.

A pressure setting biassing spring may be provided to act upon the second moveable member to oppose the outlet pressure of the pressure reducing valve. The biassing force of the pressure setting biassing spring is preferably adjustable.

One of the first or second moveable members preferably comprises first and second diaphragms moveably mounted within the housing and which are fixedly spaced apart to define an inlet chamber therebetween.

The pilot valve assembly preferably further comprises at least one bleed valve for bleeding air from the pilot valve, and in particular from the various chambers of the pilot valve assembly with the pilot valve assembly generally comprising an inlet chamber, an outlet chamber and a velocity head sensing chamber defined within the housing.

Preferably the pilot valve assembly uses a Pitot tube disposed in the outlet and outlet flow from the pressure reducing valve to sense the outlet velocity head. Such a Pitot tube enables the velocity head to be sensed without imposing a significant flow impediment in the pressure reducing valve outlet. The Pitot tube also provides a direct and amplified sufficient pressure signal in response to a change in flow which can be directly used to operate the pilot valve.

In an embodiment of a second aspect of the invention there is provided a pilot valve assembly for controlling a pressure reducing valve. The pilot valve comprises a first movable member and a second moveable member that are movable relative to each other. The first movable member includes a hollow tubular supply ring having an internal bore that is connected to an inlet of the pilot valve for supplying fluid to a nozzle that is mounted upon a radially inner portion of the supply ring for discharging fluid radially inwardly of the supply ring. The second moveable member includes a pilot valve seat that opposes the nozzle. Movement of the first and second moveable members which are movable relative to each other moves the valve seat relative to the nozzle to variably restrict the flow of fluid from the nozzle and through the pilot valve from the inlet.

The use of such a configuration, and in particular use of a supply ring provides a balanced flow of fluid to the nozzle, and a stable mounting of the nozzle within the assembly. This improves the overall stability and operation of the system.

In an embodiment of a third aspect of the invention there is provided a pilot valve assembly for controlling a pressure reducing valve. The pilot valve comprises a housing, a first moveable member moveably mounted within the housing, and an outlet duct which is variably opened and closed as the first movable member moves within the housing to control the pressure reducing valve. The first moveable member comprises first and second diaphragms spaced apart along the first moveable member and moveably mounted within the housing. The first and second diaphragms define a fixed volume inlet chamber therebetween that is moveable within the housing with the first moveable member and which is connected to an inlet of the pilot valve. The outlet duct is connected to the inlet chamber.

The diaphragms used preferably comprise a moveable portion moveably located within the housing and a flexible portion extending from the moveable portion and fixedly attached to the housing defining a seal between the moveable portion and the housing. Such diaphragms, known as rolling diaphragms, provide a good seal without introducing excessive friction and allowing relatively free movement.

In another aspect of the invention there is provided a pilot valve for controlling operation of a hydraulically-actuated pressure reducing valve. The pilot valve includes a housing and moveable valve members, each moveable valve member being mounted with at least one diaphragm. A first valve member is mounted in the housing and includes a single diaphragm and a seat for movement relative thereto in response to the outlet pressure of the pressure reducing valve. A second valve member is mounted in the housing and includes two counter opposed pistons defined by two diaphragms of equal area, and a nozzle for movement relative thereto. Also included in the second valve member is a chamber between the two counter opposed pistons from which the controlling flow is communicated to the nozzle such that movement of the second valve member is due to the magnitude of the force generated by a differential pressure signal due to flow through the pressure reducing valve (velocity head), acting across the diaphragms against a biassing reaction spring also acting on the second valve member, and wherein due to the generation and application of equal and opposite forces on the aforesaid diaphragms movement of the second valve member is not subject to changes to the inlet pressure applied inside the chamber. The pilot valve being connected and configured to control operation of the pressure reducing valve according to the relative positions of the first and second valve members.

A proportion of the differential pressure signal due to flow through the pressure reducing valve (velocity head) acts on opposite sides of the two counter opposed pistons to balance the operation. In addition the outlet static pressure is preferably connected and acts on opposite sides of the two counter opposed pistons to balance the operation of the control valve in the static flow and equilibrium conditions.

The seat of the said first valve member is contained within the inside footing of a yoke or stirrup assembly and the nozzle of said second valve member, preferably supported on the inside of a toroidal ring, is so arranged with piping from the aforesaid chamber to discharge fluid onto the said seat. The control of the pressure reducing valve is then preferably determined by the separation distance between the nozzle and the seat.

The second valve member is preferably axially guided by a location hole in the reaction plate and mounting within the housing and chambers.

The stiffness of a resiliently biassing spring placed between the nozzle side of the second valve member and a reaction plate secured against the housing preferably determines the relationship between the outlet pressure as a function of the differential pressure across the diaphragms as generated by the dynamic head produced by flow through the pressure reducing valve.

Preferably a manually adjustable valve, preferably located in externally mounted pipe work linking the chamber on one side of one of the pistons of the second valve member provided with the dynamic (velocity) head and the outlet pressure chamber on the other side of the other of the pistons of the second member, is provided to alter the differential pressure across the diaphragms of the second valve member and so alter the variation in the relationship between the outlet pressure and flow through the pressure reducing valve.

An adjustable mechanical stops is preferably provided to limit movement of the valve members and so alter the range of outlet pressures.

A needle valve is may be incorporated between the signal pressure connection sensing the dynamic (velocity) head and pilot valve to enable control of the rate of change of the outlet pressure.

The pilot valve may be installed in a horizontal position. Preferably this may enable outlet pressure control when the dynamic pressure is less than the vertical distance between the outlet of the nozzle and the diaphragm furthest most from the nozzle of the second valve member.</p>

The present invention will now be described by way of example only with reference to the following figures in which:

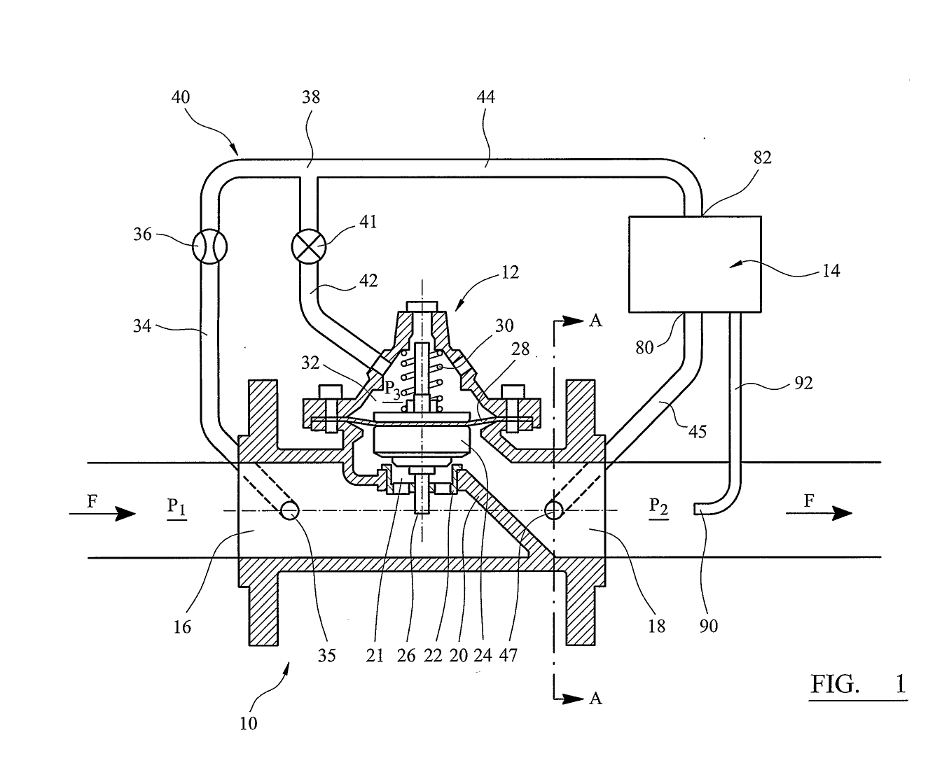

FIG. 1 is a schematic cross sectional illustration of a pressure reduction system including a main valve and pilot control valve in accordance with an embodiment of the present invention;

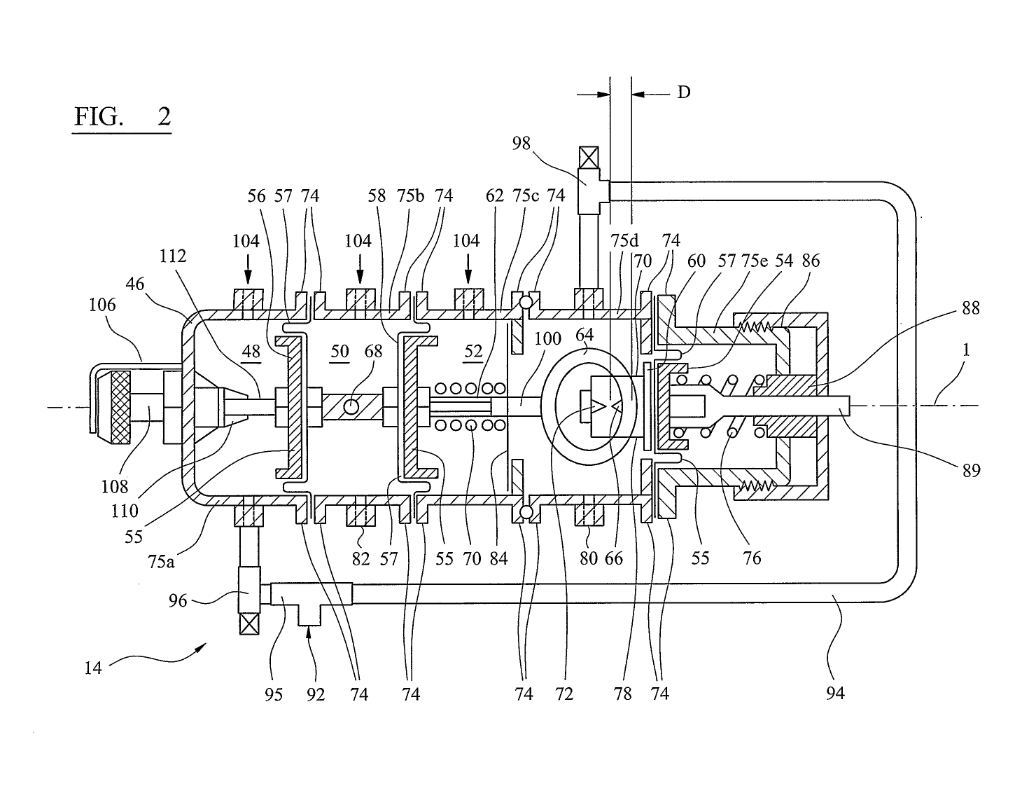

FIG. 2 is a more detailed cross sectional view of the pilot control valve of the pressure reduction system shown in FIG. 1; and

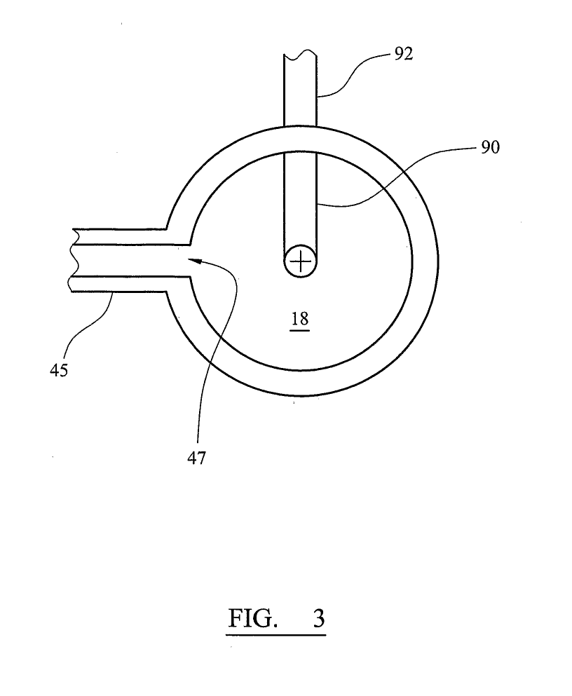

FIG. 3 is a cross sectional view on section A-A and through the outlet of the main valve of the pressure reducing valve of FIG. 1 showing the outlet pressure tapping and Pitot tube.

Referring to FIG. 1 a pressure reduction system 10 for a water supply includes a main pressure reducing valve (PRV) 12 and a pilot control valve 14. The main PRV 12 is conventional and includes an inlet 16 and an outlet 18 which are connected to the water supply system to convey water in the direction shown by arrow F through the main valve 12 and onward to a consumer. The inlet 16 and outlet 18 are connected to one another through a valve seat 22 defining an aperture 21 through a dividing wall 20 of the valve 12. A valve body 24 is mounted on a valve stem 26 for movement towards and away from the valve seat 22. The valve body 24 is mounted on a flexible diaphragm 28, above which there is a main valve biassing spring 30, and a chamber known as the control space 32. The position of the valve body 24 relative to the valve seat 22 opens and closes the valve 12 and determines pressure drop across the valve 12 and between the inlet 16 and outlet 18. When the valve body 24 is close to the valve seat 22 the main valve 12 is relatively closed and restricts the flow F such that there is a large pressure drop across the valve 12 and between the inlet 16 and outlet 18. When the valve body 24 is further away from the valve seat 22 (i.e. moved upwards) the valve 12 is more open and there is relatively little pressure drop across the valve 12 and between the inlet 16 and outlet 18.

While the main valve biassing spring 30 biases the valve body 24 towards the valve seat 22, the position of the valve body 24 relative to the seat, and so opening of the valve, is principally determined by pressure differential across the diaphragm 28 upon which the valve body 24 is mounted, and hence the relative pressure in the control space 32. This in turn is controlled by a pilot loop 40 and the pilot control valve 14. Specifically the inlet 16 is connected to the control space 32 via a first small bore pipe 34, an orifice plate (or other restrictor) 36, a T-junction 38, a speed control needle valve 41, and a second pipe 42. A third pipe 44 extends from the T-junction 38 to the pilot valve 14, and a fourth pipe 45 extends from pilot valve 16 to the outlet 18. In operation when the pilot valve 14 is fully open more pressure is relieved from the control space 32 than can be supplied from the inlet 16 via the first pipe 34 and restrictor 36, and the pressure in the control space 32 is reduced so opening the main valve 12. It is noted that the restrictor 36 provides a restriction and pressure drop from the inlet 16. If the pilot valve 14 is closed pressure from the inlet 16 supplied via the first pipe 34 and restrictor 36 builds up in the control space 32. Since the area of the diaphragm 28 at the base of the control space 32 and upon which the valve seat 24 is mounted is greater than the area of the valve body 24 below and subject to the inlet pressure P1, there is overall a closing force on the valve body 24 and the valve body 24 is urged downwards (as shown) towards the valve seat 22 and the main valve 12 closes. Modulation of the pilot valve 14, to selectively and/or partially open and close the pilot valve 14, thereby correspondingly partially or fully opens and closes the main valve 12. This then varies the pressure drop provided by and across the main valve 12 and between the inlet 16 pressure and outlet 18 pressure.

As such the pressure reduction system 10 and operation of the main PRV 12 using the pilot control valve 14 and pilot loop 40 is generally conventional.

Referring now to FIG. 2, the pilot control valve 14, in accordance with an embodiment of the invention, comprises a closed cylindrical housing assembly 46 which is divided into a series of chambers 48,50,52,54 along its axial length by a series of axially spaced apart moveable rolling diaphragms 56,58,60. The housing assembly 46 is preferably made up in sections 75a-e each having abutting end flanges and which are coaxially joined together to form the housing assembly 46. Each of the rolling diaphragms 56,58,60 preferably comprises rigid former disc 55 upon which is mounted a flexible (for example rubber) member 57 which extends from the periphery of the former 55 and is clamped around its periphery between respective flanges 74 of the housing assembly 46 to thereby attach the diaphragm 28 to the housing assembly 46. The formers 55 are of a smaller diameter than the internal diameter of the housing assembly with the flexible members 76 extending beyond the periphery of the formers 55 to the housing assembly 46. The diaphragms 56,58,60 are arranged such that they are moveable axially, as required without loading the flexible member 76 and thereby provide a frictionless moveable seal.

The first 56 and second 58 diaphragms are axially spaced apart and fixed on a central shaft 62 which extends axially from the first diaphragm 56 to the second diaphragm 58 and then through and from the second diaphragm 58. A distal end of the shaft 62 is connected to one side of an annular ring member 64 disposed with its axis perpendicular to the axis 1 of the shaft 62 and housing assembly 46. The shaft 62 and ring 64 are hollow and an inlet opening 68 is provided within a portion of the shaft 62 extending between the first 56 and second 58 diaphragms. The ring member 64 has an outlet nozzle 66 located diametrically opposite to the side of the ring connected to the shaft 62 and directed radially inwardly with respect to the ring member 64, in an axial direction towards the second diaphragm 58. The shaft 62, ring member 64 and first and second diaphragms 56,58 are all axially moveable within the housing assembly 46 with the first and second diaphragms 56,58 centrally supporting the shaft 62 and ring member 64 within the housing assembly 46. The shaft 62, ring member 64 and first and second diaphragms 56,58 together all form a first moveable member 100 of the pilot valve 14. A biassing spring 70 mounted on the shaft 62 acts between the second diaphragm 58 and a support plate 72 connected to the housing to bias the first movable member 86 to a null position.

The third diaphragm 60 spaced axially from the second diaphragm 58 and separately mounted within the housing assembly 46 supports a yoke 78 which extends axially towards and around the ring member 64. A valve seat 72 is supported by the yoke 78 within the ring member 64 in a position facing and opposing the outlet nozzle 66. The third diaphragm 60, yoke 78, and pilot valve seat 72 together all form a second moveable member 102 of the pilot valve 14. The second moveable member 102 is accordingly moveable both relative the housing assembly 46, and relative to the first moveable member 100.

A pilot valve inlet port 82 defined in the housing assembly 46 connects the inlet chamber 50 to the third pipe 44. A pilot valve outlet port 80 defined in the housing assembly 46 connects the outlet chamber 52 of the pilot valve 14 to the fourth pipe 45. In use water flows from the third pipe 44 into the pilot valve inlet port 82 and inlet chamber 50 from where it then flows into the hollow shaft 62 via the inlet opening 82 in the shaft 62 and around the hollow ring member 64 to the outlet nozzle 66. Water is discharged through the nozzle 66 into the outlet chamber 52 and out of the pilot valve 14 through the outlet port 80 and into the fourth pipe 45 to the outlet 18. The flow of water through the pilot valve 14 is controlled and restricted by the gap D between the nozzle 66 and pilot valve seat 72. This gap D, and so opening and closing of the pilot valve 14, is in turn set by the relative movement of the first and second moveable members 100,102, as will be explained in more detail below.

The second movable member 102, comprising the third diaphragm 60, yoke 78, and pilot valve seat 72 is biassed by a pressure setting biassing spring 76 mounted within the end chamber 54 and acting on third diaphragm 60 axially, towards the left as shown in FIG. 2. This pressure setting biassing spring 76 urges the pilot valve seat 72 away from the nozzle 66. As a result the pilot valve 12 is biassed to an open with water freely flowing through the nozzle 66, and through the pilot valve 14, so relieving the pressure in the control space 32 and opening the main valve 12. Opening of the main valve 12 leads to the downstream pressure P2 in the outlet 18 of the main valve 12 rising. This pressure P2 is fed via the fourth pipe 45 to the outlet chamber 52 of the pilot valve 14, and acts on the third diaphragm 60 against the pressure setting biassing spring 76 to move the second movable member 102 axially, towards the right as shown in FIG. 2, urging the valve seat 72 towards and against the nozzle 66 until the pressure in the outlet chamber 52 is balanced by the biassing spring 76 force. This restricts the flow out of the nozzle 66, restricting the flow through the pilot valve 14 and so building up pressure P3 in the control space 32 closing the main valve 12. Closure of the main valve 12 however results in a drop in downstream outlet pressure P2 and so the reverse movement of the second valve member 102 opening the pilot valve 14 and opening the main valve 12. An equilibrium or balance position, and outlet pressure P2 is therefore reached and maintained by the pilot valve 14 in which the pressure in the outlet chamber 52, and so outlet pressure P2 is balanced by the and set by the force of pressure setting biassing spring 76. This position and a base outlet pressure P3 can then be manually varied and set by adjusting the compression in the pressure setting spring 76 using a threaded end cap 86 which is threadably engaged on the end section 75e of the housing assembly 76. Turning the end cap 86 moves the end cap axially which varies the compression of the spring and base pressure setting and compresses the spring 76 through a spacer 88 amounted on an axially extending coaxial spring guide 89. It will however be appreciated that other spring adjuster arrangements could be used in other embodiments. The second movable member 102 thereby maintains a set outlet 18 pressure P3 of the main valve 12 against the biassing spring 76.

A Pitot tube 90 is mounted in the outlet 18. As shown in FIGS. 1 and 3 the Pitot tube 90 faces into the direction of flow F through the outlet 18 and is located in the centre of the outlet 18. The Pitot tube 90 is relatively small and does not pose a significant flow obstruction. The Pitot tube 90 senses the dynamic or velocity head of the water flowing through the outlet 18. It should be noted that the ends of first and fourth pipes 34, 45 comprise tappings and plain openings 35,47 in the side walls of the inlets 16 and outlets 18, and are therefore subject to the static pressure P1, P2 in the inlet 16 and outlet 18. The Pitot tube 90 is connected to a fifth pipe 92 leading to a T-junction 94 which is connected via a sensitivity needle valve 92 to a velocity head chamber 48 of the pilot valve 14, and via a sixth pipe 94 and a modulation needle valve 98 also to the outlet chamber 52. The sensitivity needle valve 96 restricts the speed with which the pressure in the velocity head chamber 48 changes, since the velocity head chamber 48 is substantially closed. The modulation needle valve 98 provides a restriction in the flow from the Pitot tube into the outlet chamber 52 and so provides a variable pressure drop in the pressure and flow from the Pitot tube into the outlet chamber 52.

In use, when there is no flow the Pitot 90 will sense the downstream static pressure P2, and the pressure in velocity head chamber 48 will be the same as in the outlet chamber 52 such that the first movable valve member 100 will remain in the null position, further biassed by the biassing spring 70. As a flow from the outlet 18 increases, due for example, to consumer demand, the velocity head sensed by the Pitot 90 will increase. This increased velocity head pressure will be fed via the sensitivity valve 92 to the velocity head chamber 48, and will act on the first diaphragm 56, overcoming the light biassing force of the spring 70 and moving the first moveable member 100, as shown to the right, and so moving the nozzle 66 away from the pilot valve seat 72. This will open the pilot valve 14 and so open the main valve 12 to increase the outlet pressure P2 (after perhaps an initial slight drop due to the increased flow). The resulting flow induced increased outlet pressure P2 will lead to an increase in the pressure in the outlet chamber 52 which will oppose the velocity head pressure in the velocity head chamber 48 until a new equilibrium is set at an increase outlet pressure P2 in response to the increase in flow sensed. A new equilibrium axial position of the first valve member 100, further to the right as shown) is then established for this increased flow, and at a higher outlet 18 pressure P2. Any decrease in the flow will lead to a decrease in the velocity head, and the reverse movement, reducing the outlet pressure P2 to a new equilibrium. In other words as the flow increases the first movable member 100 moves to the right, towards the second movable member 102, with the second movable member 102 also then in due course and in response moving to the right, against the biassing spring 76 to establish a higher outlet pressure P2.

The degree of movement, of the first moveable member 100, and so degree of increase in outlet pressure P2 in response to increased flow is controlled by the modulator valve 98. The sixth pipe 94 and modulator valve 98 interconnect the velocity head chamber 48 and outlet chamber 52. The modulator valve 98 thereby also feeds a proportion of the velocity head via the sixth pipe 94 into the outlet chamber 52. This acts on the second diaphragm 58 and opposes the pressure on the first diaphragm 56 from the velocity head chamber 48. This enables a balanced and controlled increase in the outlet pressure P2 to be provided, and the degree of increase in outlet pressure P2 in response to an increase in flow to be adjusted.

Overall therefore in the pilot valve 14 movement of the second moveable member 102 sets and varies the set outlet pressure P2 in response to the flow rate sensed by the Pitot tube 90, whilst the movement of the second movable member 102 maintains the required set outlet pressure P2 of the PRV main valve 12. The pilot valve 14 therefore provides a hydraulic control of the pressure drop provided by the PRV 12 which can respond to variations in demand (and so flow) to increase the outlet supply pressure P2 in response to increased flow F, allowing the supply outlet pressure P2 to be matched to what is required and so overall lowered when there is a low flow demand and a high pressure P2 is not needed. Furthermore this pilot valve 14 provides such dual control of the pressure responsive to the demand and flow in a single simple integrated unit and assembly that can be easily installed and retrofitted in place of other pilot valves, and rather than using multiple additional control units as has been previously proposed.

In a typical embodiment and installation of the system with the pilot valve 14 in a mains water supply, the main PRV 12 may provide a pressure drop from an inlet pressure P1 of for example 50 m head to a base outlet pressure P2 of for example 20 m head. The system 10 may then provide a modulation of the outlet pressure P2 of typically between 5 to 15 m head over the base outlet pressure P2 for a change in flow of between 5-10 l/s. In other words as the flow requirement increases by 10 l/s the outlet pressure P2 may be increased by the pilot valve 14 from 20 m to 35 m head.

A further significant aspect of the system 10 is that the fourth pipe 45 connecting the outlet chamber 52 to the outlet 18 of the PRV 12 is significantly larger in diameter than the sixth pipe 94 which interconnects and links the outlet chamber 52 with the velocity chamber 48 and supplies the velocity head pressure from the Pitot tube 90. Indeed preferably the fourth pipe 45 is twice the diameter of the sixth pipe 94. This it has been found improves the response, and in particular speed of response of the pilot valve 14 and control of the opening and closing of the main PRV 12 in response to changes in flow rate to alter the outlet pressure P2. In particular the larger diameter connection and pipe 45 to the outlet 18 provides a reservoir of fluid to the chamber 52 allowing the movable members 100,102 and pilot valve 14 to move and respond to open and close the valve 12. In addition such a larger diameter connection via a larger diameter fourth pipe 45 supplies a greater flow of fluid and pressure to and from the outlet 18 than is supplied via the sixth pipe 94 to the outlet chamber 52. As a result changes in the outlet pressure P2 are fed to the outlet chamber more rapidly and significantly than the changes from the velocity head pressure also sent to the outlet chamber 52 (it being noted that changes in the velocity head are also separately sent to the velocity head chamber 48). Accordingly for an increase in flow as well as the velocity head being supplied to the velocity chamber 48 moving the first moveable valve member 100 to the right as shown, there will also be an instantaneous initial slight drop in outlet pressure P2 due to the increased flow. The larger diameter fourth pipe 45 transmits this to the outlet chamber 52 where the pressure will additionally act on and draw the second diaphragm to the right complementing the force provide by the velocity head in the velocity head chamber 48. Due to the size difference the sixth pipe 94 will only later deliver the increased sensed velocity head to the outlet chamber 52 via the sixth pipe 94 to counteract and balance out to some degree the force provide by the increased velocity head in chamber 48 to stabilise the movement of the first movable member 100. By this time though the outlet pressure P2 will also have increased in response to the opening of the main valve 12. A similar situation also operates in reverse when the flow reduces. Accordingly by virtue of the difference in diameter of the pipes 45,94 the response speed of the valve 14 is improved while by feeding the velocity head to the outlet chamber 52 balance and stability of the velocity head modulation of the valve to increase the outlet pressure P2 is maintained.

The pilot loop 40 may also include a speed control valve 41, typically a needle valve, to regulate the flow and pressure supplied to the control space 32. This speed valve 41, similarly to the sensitivity valve 96, restricts the flow and delivery of pressure and fluid into the closed control space 32 thereby varying the speed at which the pressure and fluid in the control space 32 varies in response to changes provided by the pilot vale 14. By adjusting the restriction provided by the speed valve 41 the speed of the response of the PRV 12 can also be varied. For example with the speed valve 41 fully open and providing no restriction the main valve 12 will respond rapidly in response to changes provided by the pilot valve 14. Such a rapid response is preferable and required when there is only a relatively small pressure drop required to be provided by the main PRV 12 between the inlet pressure P1 and outlet pressure P2. Conversely with the speed valve 41 providing a restriction the pressure in the control space 32 varies more slowly and behind changes provided by the pilot valve 14, and the main valve 12 responds more slowly. Such a slower response is preferable when there is a large pressure drop required to be provided by the main PRV 12 between the inlet pressure P1 and outlet pressure P2. The speed control valve 41 therefore provides a further control of the response of the system 10.

An adjustable end stop 106 to limit the movement of the first movable member 100 may preferably provided to set the null position of the first moveable member 100, against the biassing spring 70, and thereby set a minimum outlet pressure P2 when there is no flow and no velocity head in chamber 48. The end stop 106, as shown comprises a threaded bolt 108 which extends through an end of the housing 46 and has a distal end 110 that abuts against an end spigot 112 of the first movable member 100 to limit movement of the first moveable member 100. By turning the bolt 108 into and out of the threaded engagement in the end of the housing assembly 46 the position of the distal end 110 of the bolt 112, and so limit on movement of the first moveable member 100 can be adjusted thereby adjusting the null position of the first moveable member 100 and of the nozzle 66.

The pilot valve 14 also preferably includes a series for bleed valves 104, one for each chamber 48,50,52. These bleed valves 104 are important in that they allow any air trapped in the chamber 48,50,52 or the pilot valve 14 to be removed. Any such trapped air in the chamber 48,50,52 would seriously adversely affect operation of the pilot valve since the air is compressible and would alter the pressure characteristics and loads on the diaphragms. This would lead to massive instability in the control provided by the pilot valve and severe operational consequences. The pilot valve is located horizontally with the axis 1 of the valve horizontal. The pilot valve 14 does not need to be held vertical, as with some other proposals, and accordingly it is easier to locate and mount when installed in existing supply arrangements. The bleed valves 104 are then located on one upper side of the pilot valve 14 in order to vent any trapped air which will collect along the upper side of the pilot valve 14.

The Pitot tube 90 in the illustrated embodiment comprises a separately located tube 90 extending through a separate tapping in the outlet 18 wall. In other embodiments however the Pitot tube 90 could be combined with the main outlet tapping 47 and pipe 45, with the Pitot tube 90 extending, for example, down the centre of the fourth pipe 45 and tapping 47 and then projecting into the centre of the outlet 18 similarly to as shown in FIG. 3. Such a combined arrangement would reduce the number of tappings in the outlet 18 wall.

As shown, the water is supplied from the inlet port 82 of the pilot valve 14 to the nozzle 66 of the pilot valve 14 via a supply ring 64, hollow shaft 62 and inlet chamber 50. This arrangement is particularly advantageous and includes two further aspects of the invention which may be used separately in other similar pilot control valve arrangements.

Firstly the inlet chamber arrangement 50 in which a fixed volume inlet chamber 50 is defined between two rolling diaphragms 56,58 which are fixedly spaced apart in this case by the shaft 62, but which can move together within the housing 46 provides a simple and convenient way to supply the water to the central shaft 62 and nozzle 66. In particular this arrangement avoids the use of O-rings or other interference seal arrangements which may be prone to leakage and wear, whilst still allowing water to be supplied to the moveable first member 100 and nozzle 66 which are free to move in the housing 46. The arrangement also does not provide any significant restriction on the movement of the first moveable member 100 with rolling diaphragms 56,58 providing a frictionless seal in contrast to any interference seal arrangements and use of O-ring seals. This also means that the pilot valve 14 can respond quicker and in a smooth more stable manner than can be the case with other sealing arrangements and methods of supply fluid to the nozzle 66. In addition since the chamber 50 is of a fixed volume the inlet chamber 50 does not introduce any significant variation in pressure or restriction in the flow to the nozzle 66 even as the first member 100.

Secondly the supply ring arrangement on the end of the shaft to supply the nozzle provides balanced flow to nozzle, via each branch of the ring. Furthermore the ring structure 64 securely and symmetrically holds the nozzle 66 in place under the loads preventing movement and deflection of the nozzle 66 and thereby providing a more consistent operation of the pilot valve 14. It will be noted that it is the position of the nozzle 66 relative to the pilot valve seat 72 that is critical in determining the opening of the pilot valve 14 and control provided. In addition with the nozzle 66 configured such that it is directed radially inwardly with respect to the supply ring 64, the loads generated on the nozzle 66 by the flow through it can be better carried and reacted by the ring, and first moveable member 100, in balanced manner.

It will be appreciated that many modifications to the detailed arrangement of the particular embodiment described are possible. In particular it will be appreciated that in an alternative embodiment the pilot valve inlet 82 could be connected to the second moveable member 102 (possibly similarly via two spaced apart diaphragms) with the nozzle 66 being mounted on the second movable member 102 and the pilot valve seat 72 mounted on the first movable member 100.

In the above description of the invention, certain terminology has been used for the purpose of reference only, and are not intended to be limiting. Terms such as “upper”, “lower”, “above”, “below”, “rightward”, “leftward”, “clockwise”, and “counterclockwise” refer to directions in the drawings to which reference is made. Terms such as “inward” and “outward” refer to directions toward and away from, respectively, the geometric centre of the component described. Terms such as “front”, “rear”, “side”, “left side”, “right side”, “top”, “bottom”, “horizontal”, and “vertical” describe the orientation of portions of the component within a consistent but arbitrary frame of reference which is made clear by reference to the text and the associated drawings describing the component under discussion. Such terminology will include the words specifically mentioned above, derivatives thereof, and words of similar import.

The principle and mode of operation of this invention have been explained and illustrated in its preferred embodiment. However, it must be understood that this invention may be practised otherwise than as specifically explained and illustrated without departing from its spirit or scope.

1. A pilot valve assembly for controlling a pressure reducing valve having an inlet and an outlet, the pilot valve comprising:
a housing;
a first moveable valve member moveably mounted within the housing; and
a second moveable valve member moveably mounted within the housing, and moveable relative to the first moveable valve member;
wherein relative movement of the first and second moveable valve members opens and closes the pilot valve to control the pressure reducing valve, and
wherein the second moveable member is mounted within the housing for movement relative thereto in response to the outlet pressure of the pressure reducing valve, and the first movable member is mounted within the housing for movement relative thereto in response to a sensed outlet velocity head of the outlet flow from the main valve.

2. A pilot valve assembly according to claim 1 wherein the first movable member is mounted within the housing such that the outlet velocity head is configured to act on a first side of the first moveable member.

3. A pilot valve assembly according to claim 2 further comprising a sensitivity valve to variably restrict the sensed outlet velocity head acting on a second side of the first movable member.

4. A pilot valve assembly according to claim 2 wherein a static outlet pressure of outlet flow from the main valve is configured to act on a second side of the first movable member.

5. A pilot valve assembly according to claim 1 wherein a proportion of sensed outlet velocity head is configured to act on a second side of the first movable member.

6. A pilot valve assembly according to claim 5 further comprising a modulator valve to vary the proportion of the sensed outlet velocity head configured to act on a second side of the first movable member.

7. A pilot valve assembly according to claim 1 wherein the first moveable member comprises a moveable diaphragm assembly which divides at least a portion of the housing into a velocity head chamber connected to the sensed outlet velocity head on one side of the diaphragm assembly, and an outlet chamber on the other side of the diaphragm assembly and connected to the outlet of the pressure reducing valve.

8. A pilot valve assembly according to claim 7 wherein the diaphragm assembly comprises a moveable portion moveably located within the housing and a flexible portion extending from the moveable portion and fixedly attached to the housing defining a seal between the moveable portion and the housing.

9. A pilot valve assembly according to claim 1 wherein the second moveable member comprises a diaphragm acted on by the outlet pressure of the pressure reducing valve.

10. A pilot valve assembly according to claim 9 wherein the second moveable member comprises a diaphragm defining a wall of the outlet chamber and acted on by the outlet pressure of the pressure reducing valve.

11. A pilot valve assembly according to claim 9 wherein the diaphragm comprises a moveable portion moveably located within the housing and a flexible portion extending from the moveable portion and fixedly attached to the housing defining a seal between the moveable portion and the housing.

12. A pilot valve assembly according to claim 1 wherein a pressure setting biassing spring acts upon the second moveable member to oppose the outlet pressure of the pressure reducing valve.

13. A pilot valve assembly according to claim 12 wherein the biassing force of the pressure setting biassing spring is adjustable.

14. A pilot valve assembly according to claim 1 wherein the first and second moveable members define flow passage though the pilot valve from an inlet to an outlet of the pilot valve, and that is configured to open and close in response to movement of the first and second moveable members.

15. A pilot valve assembly according to claim 14 wherein first and second moveable members comprise a nozzle and an opposing seat mounted respectively on the first and second moveable members and defining the flow passage.

16. A pilot valve assembly according to claim 15 wherein the nozzle and seat are located within an outlet chamber of pilot valve.

17. A pilot valve assembly according to claim 14 wherein nozzle is mounted upon one side of a hollow tubular supply ring that supplies fluid to the nozzle and is mounted on one of said first or second moveable members.

18. A pilot valve assembly according to claim 17 wherein the nozzle is mounted on a radially inner portion of the supply ring for discharging fluid radially inwardly of the supply ring.

19. A pilot valve assembly according to claim 14 wherein one of the first or second moveable members comprises first and second diaphragms moveably mounted within the housing and which are fixedly spaced apart to define an inlet chamber therebetween.

20. A pilot valve assembly according to claim 19 wherein at least one of the first and second diaphragms comprises a moveable portion moveably located within the housing and a flexible portion extending from the moveable portion and fixedly attached to the housing defining a seal between the moveable portion and the housing.

21. A pilot valve assembly according to claim 1 further comprising at least one bleed valve for bleeding air from the pilot valve.

22. A pilot valve assembly according to claim 21 wherein a bleed valve is provided for each chamber of the valve.

23. A pilot valve assembly according to claim 1 wherein the assembly comprises an inlet chamber, an outlet chamber and a velocity head sensing chamber defined within the housing.

24. A pilot valve assembly according to claim 1 further comprising a Pitot tube disposed in the outlet and outlet flow from the pressure reducing valve to sense the outlet velocity head.

25. A pilot valve assembly for controlling a pressure reducing valve having an inlet and an outlet, the pilot valve comprising:
a housing;
a first moveable member moveably mounted within the housing, and comprising:
a hollow shaft having an internal bore;
first and second diaphragms fixed axially spaced apart along the shaft and moveably mounted within the housing, the first and second diaphragms dividing the housing with the first diaphragm and housing defining a velocity head chamber at one end of the first moveable member, the second diaphragm and housing defining an outlet chamber at the opposite end of the first moveable member, and an inlet chamber defined between the first and second diaphragms and interconnected with the bore of the shaft; and
an outlet nozzle mounted on an end of shaft within the outlet chamber and connected to the internal bore of the hollow shaft;
a second moveable member moveably mounted within the housing with the first and second moveable members also being moveable relative to each other, the second moveable member comprising:
a third diaphragm defining a portion of the outlet chamber;
a yoke mounted on the third diaphragm and extending within the outlet chamber; and
a valve seat supported by the yoke and opposing the nozzle to variably restrict the flow of fluid from the nozzle as the first and second moveable members are moved relative to each other;
a Pitot tube located within the outlet of the main valve for sensing the velocity head of a flow through the outlet, the Pitot tube being connected to both the velocity head chamber and via a modulation valve to the outlet chamber;
an inlet duct connected to the inlet chamber and via a control chamber of the pressure reducing valve to the inlet of the pressure reducing valve; and
an outlet duct connected to the outlet chamber and to the outlet of the pressure reducing valve.

26. A pilot valve assembly for controlling a pressure reducing valve, the pilot valve comprising:
a first movable member including a hollow tubular supply ring having an internal bore that is connected to an inlet of the pilot valve for supplying fluid to a nozzle that is mounted upon a radially inner portion of the supply ring for discharging fluid radially inwardly of the supply ring; and
a second moveable member including a pilot valve seat that opposes the nozzle;
wherein the first and second moveable members are movable relative to each other to move the valve seat relative to the nozzle to variably restrict the flow of fluid from the nozzle and through the pilot valve from the inlet.

27. A pilot valve assembly for controlling a pressure reducing valve, the pilot valve comprising:
a housing;
a first moveable member moveably mounted within the housing and comprising first and second diaphragms spaced apart along the first moveable member and moveably mounted within the housing, the first and second diaphragms defining a fixed volume inlet chamber therebetween that is moveable within the housing with the first moveable member and which is connected to an inlet of the pilot valve; and
an outlet duct that is connected to the inlet chamber and which is variably opened and closed as the first movable member moves within the housing to control the pressure reducing valve.
